(19) United States
(12) Patent Application Publication
(10) Pub. No.: US 2024/0363846 A1
(43) Pub. Date: Oct. 31, 2024

(54) NEGATIVE ELECTRODE MIXTURE, METHOD FOR PRODUCING NEGATIVE ELECTRODE MIXTURE, AND SECONDARY BATTERY

(71) Applicant: TOYOTA JIDOSHA KABUSHIKI KAISHA, Toyota-shi Aichi-ken (JP)

(72) Inventors: Hideaki Nishimura, Sunto-gun Shizuoka-ken (JP); Kazushige Nomoto, Sunto-gun Shizuoka-ken (JP)

(73) Assignee: TOYOTA JIDOSHA KABUSHIKI KAISHA, Toyota-shi Aichi-ken (JP)

(21) Appl. No.: 18/645,649

(22) Filed: Apr. 25, 2024

(30) Foreign Application Priority Data
Apr. 28, 2023 (JP) 2023-074789

(51) Int. Cl. H01M 4/38; H01M 4/02; H01M 4/1395; H01M 4/62

(52) U.S. Cl. CPC H01M 4/386; H01M 4/1395; H01M 4/623; H01M 2004/027

(57) ABSTRACT

Disclosed is a negative electrode mixture capable of improving cycle characteristics of a secondary battery. The negative electrode mixture of the present disclosure includes active material secondary particles and a sulfide solid electrolyte, wherein the active material secondary particles include a plurality of silicon particles and a polymer binding the silicon particles, and the polymer has a property of 0.37≤ε_{A}/ε_{B} (wherein ε_{A} is bending strain of molded body A, the molded body A is a molded body consisting of the polymer and the sulfide solid electrolyte and including 20% by volume of the polymer and having a filling ratio of 90%, ε_{B} is bending strain of molded body B, and the molded body B is a molded body consisting of the sulfide solid electrolyte and having a filling ratio of 90%).

### CROSS-REFERENCE TO RELATED APPLICATIONS

This application claims priority to Japanese Patent Application No. 2023-074789 filed Apr. 28, 2023, the entire contents of which are herein incorporated by reference.

### FIELD

The present application discloses a negative electrode mixture, a method for producing a negative electrode mixture, and a secondary battery.

### BACKGROUND

PTL 1 discloses a negative electrode layer for an all-solid-state battery, having active material secondary particles and a sulfide solid electrolyte, wherein the active material secondary particles include a plurality of particles containing Si or Sn, and a binder, and a void ratio of the negative electrode layer is 15% or less.

### CITATION LIST

### Patent Literature

[PTL 1] JP 2019-121557 A

### SUMMARY

### Technical Problem

A secondary battery having Si as a negative electrode active material still has room to improve in terms of cycling properties.

### Solution to Problem

As a technique for solving the above problem, the present application discloses the following plurality of aspects.

### <Aspect 1>

A negative electrode mixture, comprising active material secondary particles and a sulfide solid electrolyte, wherein
the active material secondary particles include a plurality of silicon particles and a polymer binding the silicon particles, and
the polymer has the following property:
   property: 0.37≤ε_{A}/ε_{B}
   ε_{A}: bending strain of molded body A
   molded body A: A molded body consisting of the polymer and the sulfide solid electrolyte and including 20% by volume of the polymer and having a filling ratio of 90%
   ε_{B}: bending strain of molded body B
   molded body B: A molded body consisting of the sulfide solid electrolyte and having a filling ratio of 90%.

### <Aspect 2>

The negative electrode mixture of Aspect 1, wherein
the polymer is a fluorine-based polymer.

### <Aspect 3>

The negative electrode mixture of Aspect 1 or 2, wherein
the polymer is a polyvinylidene fluoride-based polymer.

### <Aspect 4>

A method for producing a negative electrode mixture, the method comprising:
mixing at least a plurality of silicon particles and a polymer to obtain active material secondary particles, and
mixing at least the active material secondary particles and a sulfide solid electrolyte to obtain the negative electrode mixture, wherein
the polymer has the following property:
   property: 0.37≤ε_{A}/ε_{B}
   ε_{A}: bending strain of molded body A
   molded body A: A molded body consisting of the polymer and the sulfide solid electrolyte and including 20% by volume of the polymer and having a filling ratio of 90%
   ε_{B}: bending strain of molded body B
   molded body B: A molded body consisting of the sulfide solid electrolyte and having a filling ratio of 90%.

### <Aspect 5>

A secondary battery, comprising a positive electrode active material layer, an electrolyte layer, and a negative electrode active material layer, wherein
the negative electrode active material layer has a negative electrode mixture of any one of aspects 1 to 3.

### Effects

According to the negative electrode mixture of the present disclosure, it is possible to improve the cycle characteristics of the secondary battery.

### BRIEF DESCRIPTION OF DRAWINGS

FIG. 1 schematically shows an example of the active material secondary particles and sulfide solid electrolyte contained in the negative electrode mixture.

FIG. 2 schematically shows an example of the configuration of the secondary battery.

FIG. 3 shows the relation between ε_{A}/ε_{B} and capacity retention rate.

### DESCRIPTION OF EMBODIMENTS

### 1. Negative Electrode Mixture

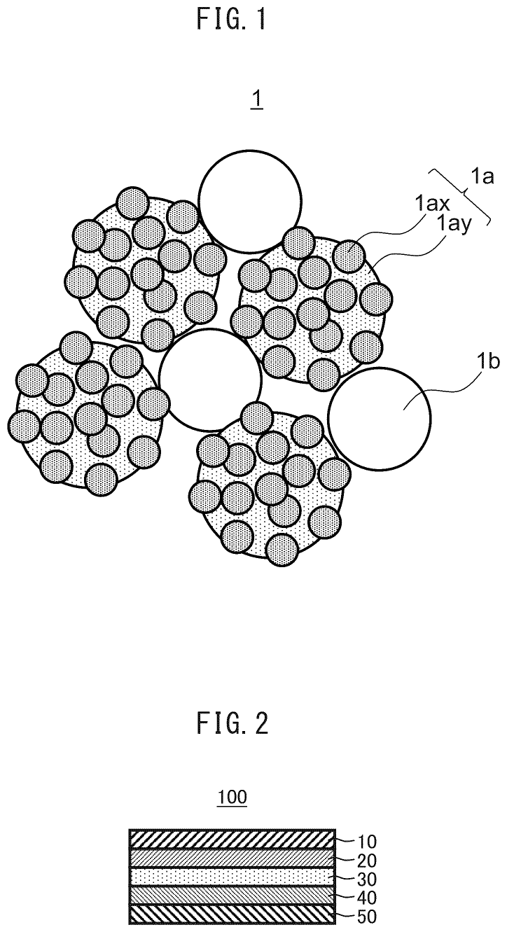

FIG. 1 shows the configuration of the negative electrode mixture 1 according to one embodiment. As shown in FIG. 1, the negative electrode mixture 1 includes active material secondary particles 1a and a sulfide solid electrolyte 1b. The active material secondary particles 1a include a plurality of silicon particles 1ax and a polymer 1ay binding the silicon particles 1ax together. The polymer 1ay has a property of 0.37≤ε_{A}/ε_{B}. Here, ε_{A} is a bending strain of a molded body A. The molded body A is made of the polymer 1ay and the sulfide solid electrolyte 1b, and contains 20% by volume of the polymer 1ay, and has a filling ratio of 90%. ε_{B} is a bending strain of a molded body B. The molded body B is made of the sulfide solid electrolyte 1b and has a filling ratio of 90%.

### 1.1 Active Material Secondary Particles

The active material secondary particle 1a includes a plurality of silicon particles 1ax and a polymer 1ay binding the silicon particles 1ax together. The polymer 1ay has the property of 0.37≤ε_{A}/ε_{B}.

### 1.1.1 Silicon Particle

The chemical composition of the silicon particle 1ax is not particularly limited. The ratio of Si element to all elements contained in the silicon particle 1ax may be, for example, 50 mol % or more and 100 mol % or less, 70 mol % or more and 100 mol % or less, or 90 mol % or more and 100 mol % or less. The silicon particle 1ax may contain other elements in addition to Si element. Other elements may be at least one of Li element, Sn element, Fe element, Co element, Ni clement, Ti element, Cr element, Al element, B element and P element. When removing Li from Si-Li alloyed particles to obtain silicon particle 1ax, the silicon particle 1ax may include Si clement and Li element. In addition, the silicon particle 1ax may contain an impurity such as an oxide. The silicon particle 1ax may be amorphous or crystalline.

The silicon particle 1ax may be porous. It is considered that when the silicon particle 1ax is porous and has a void, expansion of silicon can be absorbed by the void, the restraining pressure of the secondary battery can be reduced, and the cycling characteristic of the secondary battery can be further improved. The silicon particle 1ax may be, for example, a particle comprising nanoporous silicon. Nanoporous silicon refers to silicon in which a plurality of pores having a pore diameter on the order of nanometers (in some embodiments, less than 1000 nm, or less than or equal to 100 nm) are present. The silicon particle 1ax may be a porous silicon particle containing pores of a diameter 55 nm or less. Pore having diameter of 55 nm or less is hard to crush even by pressing. In other words, porous silicon particles containing pores having a diameter of 55 nm or less tend to be maintained in a porous state even after pressing. For example, pores having a diameter of 55 nm or less may be contained in 0.21 cc/g or more and 0.30 cc/g or less per 1 g of the silicon particle 1ax. The lower limit may be 0.22 cc/g or more, or 0.2 3cc/g or more, and the upper limit may be 0.28 cc/g or less, or 0.26 cc/g or less. The quantity of the pore having the diameter of 55 nm or less contained in the silicon particle 1ax can be calculated from, for example, the pore diameter distribution by a nitrogen-gas-adsorption method or a DFT method.

The porosity of the silicon particle 1ax is not particularly limited. The porosity of the silicon particle 1ax may be, for example, 0% or more and 80% or less. The lower limit may be 1% or more, 5% or more, 10% or more, or 20% or more, and the upper limit may be 70% or less, 60% or less, 50% or less, 40% or less, or 30% or less. Porosity of the silicon-particle 1ax, for example, can be determined by observing by a scanning-electron-microscope (SEM). In some embodiments, the number of samples is large, e.g., 100 or more. The porosity can be an average value determined from these samples.

The size of the silicon particle 1ax is not particularly limited. The particle diameter D₁ of the silicon particle 1ax may be, for example, 10 nm or more and 10 μm or less. The lower limit may be 30 nm or more, 50 nm or more, 100 nm or more, or 150 nm or more, and the upper limit may be 5 μm or less, 3 μm or less, 2 μm or less, or 1 μm or less. Note that the particle diameter D₁ of the silicon particle 1ax can be determined by observing by an electronic-microscope such as SEM, and is determined as a number-average value of the largest Ferre diameter of each of the plurality of particles. In some embodiments, the number of samples is large, for example, 20 or more, and may be 50 or more, and may be 100 or more. The particle diameter D₁ of the silicon particle 1ax can be appropriately adjusted, for example, by changing the manufacturing conditions of the silicon particles or performing the classification treatment.

The form of the silicon particle 1ax is not particularly limited. For example, the silicon-particle 1ax may be spherical or non-spherical.

The number of the silicon particle 1ax contained in the active material secondary particle 1a is not particularly limited. The number of the silicon particle 1ax contained in the active material secondary particle 1a may be 2 or more and 10000 or less. The lower limit may be 5 or more, 10 or more, 50 or more, or 100 or more, and the upper limit may be 5000 or less, 1000 or less, or 500 or less.

### 1.1.2 Polymer

The polymer 1ay has a function of binding the silicon particles 1ax together. The position of the presence of the polymer in the active material secondary particle 1a is not particularly limited. The polymer 1ay may be present on the surface layer side of the active material secondary particle 1a, or may be present on the center side, or may be present on both of these. Further, the polymer 1ay may be exposed on the surface of the active material secondary particle 1a.

The type of the polymer 1ay is not particularly limited as long as it has the characteristics described later. Whether or not the polymer 1ay has the characteristics described later depends on the type of monomer units constituting the polymer 1ay and the molecular weight of the polymer 1ay. In the present embodiment, among known polymers, those having characteristics described later may be selected and used as a polymer 1ay. The polymer 1ay may be, for example, at least one selected from butadiene rubber (BR) based polymers, butylene rubber (IIR) based polymers, acrylate butadiene rubber (ABR) based polymers, styrene butadiene rubber (SBR) based polymers, polyvinylidene fluoride (PVdF) based polymers, polytetrafluoroethylene (PTFE) based polymers, polyacrylic acid-based polymers, polyacrylic ester-based polymers, and the like. In particular, when the polymer 1ay is a fluorine-based polymer, among them, a polyvinylidene fluoride (PVdF) based polymer, high-performance is easily exhibited. The fluorine-based polymer has low reactivity with a sulfide solid electrolyte 1b described later.

Therefore, it is possible to suppress deterioration of the sulfide solid electrolyte 1b by reacting the polymer 1ay with the sulfide solid electrolyte 1b. Also from the viewpoint of ion conductivity and the like, in some embodiments, a fluorine-based polymer is selected. The polymer 1ay may be a copolymer. For example, a polyvinylidene fluoride (PVdF) based polymer may have a unit derived from a monomer other than a VdF together with a unit derived from a VdF. Only one kind of the polymer 1ay may be used alone, or two or more kinds thereof may be used in combination.

The polymer 1ay has the following property. It is considered that the active material secondary particle 1a includes a polymer 1ay having such property, so that the contact between the active material secondary particle 1a and the sulfide solid electrolyte 1b is easily achieved, and the binding force between the active material secondary particle 1a and the sulfide solid electrolyte 1b is improved, and further, since the polymer 1ay itself have the deformation performance, the separation between the active material secondary particle 1a and the sulfide solid electrolyte 1b is difficult to occur. In other words, it is considered that, even if the volume of the active material secondary particle 1a (particularly, silicon particles 1ax) in the negative electrode mixture 1 changes with charge and discharge, separation between the active material secondary particle 1a and the sulfide solid electrolyte 1b hardly occurs, and an ionic conduction pass is maintained. As a result, the cycle characteristics in the case of the secondary battery (capacity retention rate) is improved.

Property: 0.37≤ε_{A}/ε_{B}

ε_{A}: bending strain of molded body A

Molded body A: A molded body consisting of the polymer and the sulfide solid electrolyte and comprising 20% by volume of the polymer and having a filling ratio of 90%

ε_{B}: bending strain of molded body B

Molded body B: A molded body consisting of the sulfide solid electrolyte and having a filling ratio of 90%

Here, in the present application, to produce three molded bodies having different filling ratio (=true density/bulk density), to measure the bending strain of each molded body, from the relationship between the measured three bending strain and the filling ratio, using an approximate curve, to identify the bending strain at 90% filling ratio, which is regarded as “bending strain of the molded body A” or “bending strain of the molded body B”. In detail, as follows.

The “bending strain of the molded body A” is one specified as follows. First, polymer solutions are prepared by dissolving polymer 1ay in butyl butyrate. After weighing the polymer solution so that the sulfide solid electrolyte 1b and the polymer 1ay are 80:20 by volume, butyl butyrate is added so that the solid content is 28% to adjust the solution of 1.5 cc. The solution is mixed with a shaker for 9 minutes and an ultrasonic homogenizer for 1 minute and 30 seconds to obtain a slurry. The slurry is cast on a glass Petri dish, dried on a hot plate at 120° C., and then crushed to obtain a mixed powder of a polymer 1ay and a sulfide solid-electrolyte 1b The mixed powder is press-molded to obtain a molded body for bending test. Here, by adjusting the weighing value and the pressing pressure of the mixed powder, to prepare three different molded body filling ratio. Specifically, a molded body having a filling ratio of 70% and a length 20 mm, a width 2 mm, and a thickness 1 mm, and a molded body having a filling ratio of 77% and a length 20 mm, a width 2 mm, and a thickness 1 mm, and a molded body having a filling ratio of 82% and a length 20 mm, a width 2 mm, and a thickness 1 mm are prepared. Each molded body is subjected to three-point bending test described below, to identify the bending strain of each. The relationship between these three bending strains and the filling rate is plotted in a graph, and the bending strain at the filling rate of 90% is specified by subtracting an approximate curve in a linear approximation, which is regarded as “bending strain of the molded body A”.

The “bending strain of the molded body B” is one specified as follows. First, a molded body for bending test is obtained by press-molding a sulfide solid-electrolyte 1b. Here, by adjusting the weighing value of the sulfide solid electrolyte 1b and the pressing pressure, three types of molded body having different filling ratios are prepared. Specifically, a molded body having a filling ratio of 60% and a length 20 mm, a width 2 mm, and a thickness 1 mm, and a molded body having a filling ratio of 73% and a length 20 mm, a width 2 mm, and a thickness 1 mm, and a molded body having a filling ratio of 78% and a length 20 mm, a width 2 mm, and a thickness 1 mm are prepared. Each molded body is subjected to three-point bending test described below, to identify the bending strain of each. The relationship between these three bending strains and the filling ratio is plotted on a graph, and the approximate curve is drawn by a linear approximation to specify the bending strain at the filling ratio of 90%, which is regarded as “bending strain of the molded body B”.

“Bending Strain” refers to the bending strain measured by a three-point bending test in accordance with JIS K7171: 2016. Specifically, a molded body (length 20 mm width 2 mm thickness 1 mm) is manufactured by the above-described process, and the molded body is set in a bending tester so that the distance between the fulcrums is 18.5 mm, and a three point bending test is performed. The span of the bending test shall be 1 mm. The test rate of the bending test shall be 0.05 mm/min.

As described above, the polymer 1ay has a property of 0.37≤ε_{A}/ε_{B}. The upper limit of ε_{A}/ε_{B} is not particularly limited, for example, may be 1.00 or less, 0.95 or less, 0.90 or less, 0.85 or less, 0.80 or less, 0.75 or less, 0.70 or less, or 0.65 or less.

### 1.1.3 Other Ingredients

The active material secondary particle 1a may contain other components together with the above-mentioned silicon particle 1ax and polymer 1ay. The active material secondary particle 1a may contain the silicon particle 1ax and the polymer 1ay in a total amount of more than 50% by mass and 100% by mass or less, 70% by mass or more and 100% by mass or less, 90% by mass or more and 100% by mass or less, or 95% by mass or more and 100% by mass or less. Further, the active material secondary particle 1a may contain 50% by mass or more and 99% by mass or less, 70% by mass or more and 99% by mass or less, or 90% by mass or more and 99% by mass or less of the silicon particle 1ax, and may contain 1% by mass or more and 50% by mass or less, 1% by mass or more and 30% by mass or less, or 1% by mass or more and 10% by mass or less of the polymer 1ay.

### 1.1.4 Size of the Active Material Secondary Particle

It can be said that the active material secondary particle 1a is obtained by aggregating a plurality of silicon particles 1ax via a polymer 1ay. The average particle diameter of active material secondary particles 1a is not limited in particular. The average particle diameter of the active material secondary particles 1a may be 100 nm or more, 1 μm or more, 2 μm or more, or 3 μm or more, and may be 100 μm or less, 50 μm or less, 20 μm or less, 15 μm or less, or 10 μm or less. The average particle diameter of the active material secondary particles 1a can be determined by observing by an electronic-microscope such as SEM, and is determined as an average value of the maximum Ferre diameters of the plurality of secondary particles, for example. In some embodiments, the number of samples is large, for example, 20 or more, and may be 50 or more, and may be 100 or more. Alternatively, the average particle diameter (D50) of the active material secondary particle 1a measured by taking out only the active material secondary particle 1a from the negative electrode mixture material 1 may be 100nm or more, 1 μm or more, 2 μm or more, or 3 μm or more, and may be 100 μm or less, 50 μm or less, 20 μm or less, 15 μm or less, or 10 μm or less. The mean particle diameter D50 as referred to in the present application, the particle diameter (median diameter) at an integrated value of 50% in the particle size distribution on a volume basis determined by a laser diffraction/scattering method.

### 1.1.5 Method for Producing the Active Material Secondary Particle

The active material secondary particle 1a may be produced, for example, by mixing a silicon particle 1ax, a polymer 1ay, and optional components. There is no particular limitation on the mixing method, and it may be a wet mixing using a solvent or a dry mixing without using a solvent. The mixing technique is also not particularly limited, and may be mechanically mixed using various mixing devices, or may be mixed manually.

### 1.2 Sulfide Solid Electrolyte

The sulfide solid electrolyte 1b may be a glass-based sulfide solid electrolyte (sulfide glass), a glass ceramic-based sulfide solid electrolyte, or a crystal-based sulfide solid electrolyte. Sulfide glass is amorphous. The sulfide glass may be one having a glass transition temperature (Tg). In addition, when the sulfide solid electrolyte 1b has a crystalline phase, examples of the crystalline phase include a thio-LISICON type crystalline phase, a LGPS type crystalline phase, and an aldilodite type crystalline phase. The sulfide solid electrolyte 1b may contain, for example, Li clement, X element (X is at least one of P, As, Sb, Si, Ge, Sn, B, and Al, Ga, In), and S element. Further, the sulfide solid electrolyte 1b may further contain at least one of an O element and a halogen element. Further, the sulfide solid electrolyte 1b may be one which contains an S element as a main component of an anionic element. The sulfide solid electrolyte 1b may be, for example, at least one of Li₂S-P₂S₅, Li₂S-P₂S₅-LiI, Li₂S-P₂S₅-GeS₂, Li₂S-P₂S₅-Li₂O, Li₂S-P₂S₅-Li₂O-LiI, Li₂S-P₂S₅-LiI-LiBr, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂Ss-LiI, Li₂S-B₂S₃, Li₂S-P₂S₅-ZmSn (where m, n is a positive number. Z is any of Ge, Zn, Ga.), Li₂S-GeS₂, Li₂S-SiS₂-Li₃PO₄, Li₂S-SiS₂-LiₓMO_{y} (where, x, y is a positive number. M is P, Si, Ge, B, Al, Ga, or In.). Composition of the sulfide solid electrolyte 1b is not particularly limited, for example, xLi₂S: (100-x) P₂S₅ (70≤x≤80), yLil:zLiBr:(100-y-z (xLi₂S: (1-x) P₂S₅) (0.7≤x≤0.8, 0≤y≤30, 0≤z≤30) and the like. Alternatively, the sulfide solid-electrolyte 1b may have a composition represented by the general formula: Li₄₋ₓGe₁₋ₓPₓS₄ (0<x<1). In the above general formula, at least a part of Ge may be substituted with at least one of Sb, Si, Sn, B, Al, Ga, In, Ti, Zr, V and Nb. In the above general formula, at least a part of P may be substituted with at least one of Sb, Si, Sn, B, Al, Ga, In, Ti, Zr, V and Nb. In the above general formula, a part of Li may be substituted with at least one of Na, K, Mg, Ca and Zn. In the above general formula, a part of S may be substituted with halogen (at least one of F, Cl, Br and I). Alternatively, the sulfide solid electrolyte 1b may have a composition represented by Li₇₋ₐPS₆₋ₐXₐ (X is at least one of Cl, Br and I, and “a” is a number of 0 or more and 2 or less). “a” may be 0 and may be greater than 0. In the latter case, “a” may be 0.1 or more, may be 0.5 or more, and may be 1 or more. Further, “a” may be 1.8 or less, and may be 1.5 or less. The sulfide solid electrolyte 1b may be, for example, particulate. The average particle diameter (D50) of the sulfide solid electrolyte 1b may be, for example, 10 nm or more and 10 μm or less.

### 1.3 Other Ingredients

The negative electrode mixture 1 includes at least the active material secondary particles 1a and the sulfide solid electrolyte 1b described above. Further, the negative electrode mixture 1 may optionally contain other components. Examples of other components include various solid components and liquid components. For example, the negative electrode mixture 1 may contain another active material together with the active material secondary particle 1a and the sulfide solid electrolyte 1b described above. The ratio of silicon particles lax described above to all of the active materials contained in the negative electrode mixture 1 may be more than 50% by mass and 100% by mass or less, 70% by mass or more and 100% by mass or less, or 90% by mass or more and 100% by mass or less. Other active materials which may be included in the negative electrode mixture 1 may be at least one selected from graphite, lithium, and the like, for example. Further, the negative electrode mixture 1 may contain another electrolyte together with the active material secondary particle 1a and the sulfide solid electrolyte 1b described above. The other electrolyte may be a solid electrolyte other than the sulfide solid electrolyte 1b. The ratio of the above-mentioned sulfide solid electrolyte 1b to all of the electrolytes contained in the negative electrode mixture 1 may be more than 50% by mass and 100% by mass or less, 70% by mass or more and 100% by mass or less, or 90% by mass or more and 100% by mass or less. Other electrolytes which may be included in the negative electrode mixture 1 may be, for example, an oxide solid electrolyte, or an ion-binding solid electrolyte (e.g., those containing Li, Y and halogen elements as constituent elements). Further, the negative electrode mixture 1 may contain a conductive aid together with the active material secondary particle 1a and the sulfide solid electrolyte 1b described above. The conductive aid may be any of those known as a conductive material of the battery. Further, the negative electrode mixture 1 may contain a binder together with the active material secondary particle 1a and the sulfide solid electrolyte 1b described above. Any binder known as a binder for batteries can be adopted. The amount of other components that may be contained in the negative electrode mixture 1 is not particularly limited, and may be appropriately determined according to the purpose battery performance and the like.

### 2. Method for Producing Negative Electrode Mixture

The technique of the present disclosure also has an aspect as a method for producing a negative electrode mixture. In other words, a method for producing a negative electrode mixture 1 according to one embodiment includes: (1) mixing at least a plurality of silicon particles 1ax and a polymer 1ay to obtain an active material secondary particle 1a; and (2) mixing at least the active material secondary particle 1a and a sulfide solid electrolyte 1b to obtain a negative electrode mixture 1. Here, in the present embodiment, as the polymer 1ay, using those having the above property of 0.37≤ε_{A}/ε_{B}. In other words, in this embodiment, prior to manufacturing the active material secondary particle 1a, a combination of a polymeric 1ay having the above-described properties and a sulfide solid electrolyte 1b is selected. For example, a sulfide solid electrolyte 1b combined with an active material secondary particle 1a is prepared, and a “bending strain ε_{B} of the molded body B” is specified as described above. And a plurality of types of polymers are prepared and for each polymer, a “bending strain ε_{A} of the molded body A” is specified as described above. And Based on the specified εB and each of the plurality of εA, εA/εB is calculated. A combination of sulfide solid electrolyte 1b and polymer 1ay where the calculated εA/εB is 0.37 or greater is selected The selected polymer 1ay is used to produce an active material secondary particulate 1a. A negative electrode mixture 1 is prepared using the selected sulfide solid state electrolyte 1b and the active material secondary particle 1a.

### 3. Secondary Battery

FIG. 2 schematically shows a configuration of a secondary battery 100 according to one embodiment. As shown in FIG. 2, the secondary battery 100 includes a positive electrode active material layer 20, an electrolyte layer 30, and a negative electrode active material layer 40. In the battery 100 according to one embodiment, the negative electrode active material layer 40 includes the negative electrode mixture 1 described above. The problem related to the cycle characteristics is easily manifested when the secondary battery includes a solid electrolyte. In contrast, in the secondary battery 100, the negative electrode active material layer 40 includes the active material secondary particle 1a together with the sulfide solid electrolyte 1b, so that the cycling characteristic can be improved as described above. In the secondary battery 100, in addition to the negative electrode active material layer 40 containing a sulfide solid electrolyte, one or both of the positive electrode active material layer 20 and the electrolyte layer 30 may contain a sulfide solid electrolyte. In addition, in the secondary battery 100, all of the positive electrode active material layer 20, the electrolyte layer 30, and the negative electrode active material layer 40 may contain a sulfide solid electrolyte. Further, the secondary battery 100 may be a solid-state battery. The solid-state battery refers to one in which an electrolyte having carrier ion conductivity is mainly constituted by a solid electrolyte, however, a part thereof may contain a liquid component. Alternatively, the secondary battery 100 may be an all-solid-state battery substantially free of liquid components. The secondary battery 100 may have a general configuration as a battery. For example, as shown in FIG. 2, in addition to the positive electrode active material layer 20, the electrolyte layer 30, and the negative electrode active material layer 40, the secondary battery 100 may include a positive electrode current collector 10 in contact with the positive electrode active material layer 20 and a negative electrode current collector 50 in contact with the negative electrode active material layer 40. In the secondary battery 100, a configuration other than the negative electrode active material layer 40 is the same as in the prior art, and for example, a configuration as described in PTL 1 (JP 2019-121557 A) or the like can be adopted. The method of manufacturing the secondary battery 100 may be the same as in the prior art except that the negative electrode mixture 1 is used.

### EXAMPLES

Hereinafter, the technique of the present disclosure will be described in further detail with reference to Examples, but the technique of the present disclosure is not limited to the following Examples.

### 1. Characterization of polymers by bending test

### 1.1 Preparation of Bending Specimens

### 1.1.1 PVdF Based Polymer 1

PVdF based polymer 1 was dissolved in butyl butyrate to obtain polymer solutions. The sulfide solid electrolyte and the polymer solution after micronization described later were weighed so that the volume ratio of the sulfide solid electrolyte and the polymer after drying became 80:20, and further, butyl butyrate was added as a solvent, and a solution of 1.5 cc was adjusted so that the solid weight was 28%. This was mixed by a shaker for 9 minutes and an ultrasonic dispersing apparatus for 1 minutes and 30 seconds to obtain a slurry. The slurry was cast on a glass Petri dish, dried on a hot plate at 120° C., and crushed in a mortar to obtain a mixed powder of PVdF polymer 1 and the sulfide solid electrolyte. The mixed powder was weighed, to obtain a molded body for bending test (length 20 mm, widthwise 2 mm, thickness 1 mm) by press molding in a jig. Here, by changing the weighing value of the mixed powder, also by changing the pressing pressure to a 0.5˜3.5t, to obtain three forms differing in the packing ratio. For one of the molded body, the filling ratio was made to be 70%. For one molded body, the filling ratio was made to be 77%. And for one molded body, the filling ratio was made to be 82%.

### 1.1.2 PVdF Based Polymers 2 to 5

PVdF based polymers 2 to 5 having different copolymerization components and different molecular weights from those of the above PVdF polymer 1 were prepared. For each of the polymers 2 to 5, three molded bodies having different filling ratios were obtained in the same manner as described above.

### 1.1.3 BR Based Polymer

Three molded bodies having different filling ratio were obtained using BR based polymer and in the same manner as described above.

Hereinafter, a molded body containing the above-described PVdF polymer or BR polymer is referred to as a “polymer molded body”.

1.1.4 Sulfide solid electrolyte

Li₂S (Furuuchi Chemical) 0.550 g, P₂S₅ (Aldrich) 0.887 g, Lil (Nikho Chemical) 0.285 g, and LiBr (High-Purity Chemical) 0.277 g were mixed in an agate mortar for 5 minutes. To the obtained mixture, n-heptane (dehydration-grade, manufactured by Kanto Chemical Co., Ltd.) 4 g was added, and a sulfide solid electrolyte was obtained by mechanical milling using a planetary ball mill for 40 hours. The resulting sulfide solid electrolyte was further mechanically milled and atomized for 20 hours. Particles after micronization were weighed, to obtain a molded body for bending test (length 20 mm, width 2 mm, thickness 1 mm) by press molding in the jig. Here, by changing the weighing value of the sulfide solid electrolyte, and by changing the pressing pressure to 50-400 MPa, three molded bodies having different filling ratios were obtained. One molded body was made to have a filling ratio of 60%, one molded body was made to have a filling ratio of 73%, and one molded body was made to have a filling ratio of 78%.

Hereinafter, a molded body composed of the above sulfide solid electrolyte is referred to as a “solid electrolyte molded body”.

### 1.2 Bending Test

For each polymer, as described above, three polymer molded bodies having different filling ratios were prepared, and for each, a three-point bending test was performed to determine the bending strain. The measured values were plotted with the filling ratio on the horizontal axis and the bending strain on the vertical axis, and the approximate curve was drawn by linear approximation from the plots of the three points, and the bending strain ε_{A} (90% bending strain ε_{A}) at the filling ratio of 90% was specified. On the other hand, for the solid electrolyte molded bodies described above, a bending strain ε_{B} (90% bending strain ε_{B}) at the filling ratio of 90% was specified in the same manner.

### 1.3 Calculation of ε_{A}/ε_{B}

The ratio &A/EB between the 90% bending strain ε_{A} of each polymer molded body and the 90% bending strain ε_{B} of the solid electrolyte molded body was calculated. The results are shown in Table 1 below.

TABLE 1

| | Polymer | ε_{A}/ε_{B} |
|---|---|---|
| Comparative Example 1 | PVdF-based polymer 1 | 0.081 |
| Example 1 | PVdF-based polymer 2 | 0.376 |
| Example 2 | PVdF-based polymer 3 | 0.649 |
| Example 3 | PVdF-based polymer 4 | 0.588 |
| Example 4 | PVdF-based polymer 5 | 0.588 |
| Example 5 | BR-based polymer | 0.853 |

### 2. Cycle Characterization of Batteries

Using each of the above polymers, active material secondary particles were prepared, a negative electrode mixture was prepared using the active material secondary particles, a secondary battery was prepared using the negative electrode mixture, and cycle characteristics of the secondary battery were evaluated.

### 2.1 Comparative Example 1

### 2.1.1 Preparation of the Positive Electrode

A positive electrode slurry was prepared by stirring a NCM type positive electrode active material, a sulfide solid electrolyte, a vapor grown carbon fiber, a PVdF based binder, and butyl butyrate by an ultrasonic dispersing device. Here, NCM positive electrode active material: sulfide solid electrolyte: vapor grown carbon fiber: PVdF based binder was made into a 100:16:2:0.75 by mass-ratio. This positive electrode slurry was coated on an Al foil as a positive electrode current collector by a blade method, which was dried on a hot plate at 100° C. for 30 minutes to obtain a positive electrode having a positive electrode active material layer on a surface of the Al foil.

### 2.1.2 Preparation of the Negative Electrode

PVDF based polymer 1 described above was dissolved in butyl butyrate to obtain polymer solutions. The polymer solutions and Si particles (particle diameter: 0.5 μm, manufactured by High-Purity Chemical Co., Ltd.) were weighed so that Si particles: polymer became 100:8 by weight, and stirred by an ultrasonic dispersing device and a shaker to obtain a negative electrode slurry. The negative electrode slurry was cast on a glass Petri dish, dried on a hot plate, and crushed in a mortar to obtain active material secondary particles. The obtained active material secondary particles (aggregated particles) consists of a plurality of Si particles and a polymer binding Si particles together. The active material secondary particles, the sulfide solid electrolyte, the vapor grown carbon fiber, BR based binder, the mesitylene, and the dibutyl ether are stirred and mixed using an ultrasonic dispersing device and an agitator to obtain a negative electrode slurry in which the negative electrode mixture is dispersed in a solvent. Here, Si particle: polymer: sulfide solid electrolyte: vapor grown carbon fiber: BR based binder was made into 100:8:77.6:8.4:1.5 by mass-ratio. This negative electrode slurry was coated on a Ni foil as a negative electrode current collector by a blade method, and this was dried on a hot plate at 100° C. for 30 minutes to obtain a negative electrode having a negative electrode active material layer on the Ni foil.

### 2.1.3 Preparation of the Solid Electrolyte Layer

A solid electrolyte slurry was obtained by stirring the sulfide solid electrolyte, a PVdF based binder, and butyl butyrate by an ultrasonic disperser. Here, the sulfide solid electrolyte: PVdF based binder was set to 99.6:0.4 by mass-ratio. This solid electrolyte slurry was coated on an Al foil by a blade method, and this was dried on a hot plate at 100° C. for 30 minutes to form a solid electrolyte layer on the Al foil.

### 2.1.4 Preparation of Positive Electrode Laminate

A positive electrode laminate comprising a configuration of the Al foil/positive electrode active material layer/solid electrolyte layer was obtained by laminating the above positive electrode active material layer and a solid electrolyte layer, pressing the laminate with a roll press machine at a 50 kN/cm pressure and a temperature of 160° C., then peeling the Al foil from the solid electrolyte layer and punching it to 1 cm² size.

### 2.1.5 Preparation of Negative Electrode Laminate

The negative electrode active material layer and the solid electrolyte layer described above were laminated and pressed by a roll press machine at a 50 kN/cm pressure, and then the Al foil of the solid electrolyte layer was peeled off to obtain a first laminate having a configuration of the Ni foil/negative electrode active material layer/solid electrolyte layer. Further, an additional solid electrolyte layer was laminated on the solid electrolyte layer side of the first laminate, and after temporary pressing at a 100 MPa pressure and a temperature of 25° C. in a planar one axis press machine, the Al foil was peeled from the solid electrolyte layer and punched to a 1.08 cm² size to obtain a second laminate comprising a configuration of the Ni foil/negative electrode active material layer/solid electrolyte layer/solid electrolyte layer. The second laminate was used as a negative electrode laminate.

### 2.1.6 Fabrication of Battery Laminate

Laminating the above positive electrode laminate and the negative electrode laminate, and pressed at a 200 MPa and 135° C. in a plane uniaxial press machine to obtain a battery laminate having a configuration of the Ni foil/negative electrode active material layer/solid electrolyte layer/solid electrolyte layer/solid electrolyte layer/positive electrode active material layer/Al foil.

### 2.1.7 Restraint and initial charge/discharge of the battery laminate

The battery laminate was sandwiched between two restraining plates, and these two restraining plates were tightened by fasteners at 1 MPa restraining pressures to fix the distance between the two restraining plates. For this restrained battery laminate,
(1) Constant current charging of 1/10 C, to 4.55V
(2) After that, constant-voltage charging up to 4.55V and cutoff current 1/100 C
(3) After that, constant current discharging of 1 C, to 3V
(4) After that, constant-voltage discharging to 3V and cutoff current 1/100 C
(5) Thereafter, constant current charging of 1/3 C, to 4.35V were carried out. Furthermore, afterwards,
(6) Constant-voltage charging up to 4.35V and cutoff current 1/100 C
(7) After that, constant current discharging of 1/3 C, to 3V
(8) After that, constant-voltage discharging to 3V and cutoff current 1/100 C were carried out twice.

### 2.1.8 Evaluation of Cycle Characteristics by Durability Test

For the battery laminate after the above charge and discharge, the durability test was performed, and the capacity retention ratio was calculated, whereby the cycle characteristic was evaluated. Specifically, subjected to charge and discharge of 150 cycles under the following conditions, to determine the ratio of the discharge capacity C2 after 150 cycles with respect to the discharge capacity C1 of the first cycle, which was the capacity retention rate.

Charging: Constant current charging of 2 C, to 4.17V

Discharging: Constant current discharging of 2 C, to 3.14V Capacity retention rate (%): [Discharge capacity C2/Discharge capacity C1]×100

### 2.2 Examples 1-5

Battery laminates were manufactured in the same manner as in Comparative Example 1, except that PVdF based polymer 2 to 5 or BR based polymer described above was used instead of PVdF based polymer 1 as the polymer constituting the active material secondary particle, and the cycling characteristic was evaluated.

### 2.3 Evaluation Results

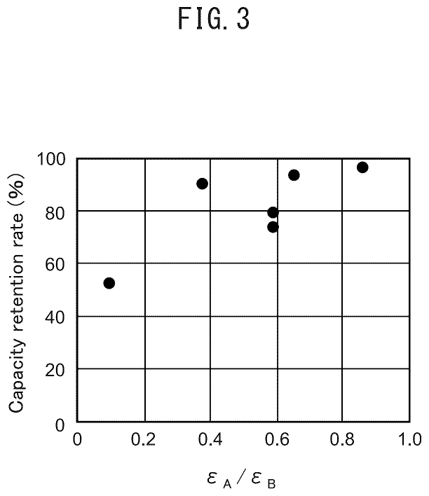

FIG. 3 shows the relation between the property ε_{A}/ε_{B} of the polymer which constitutes active material secondary particle, and a capacity retention rate. As shown in FIG. 3, when the polymer constituting the active material secondary particles has a property of 0.37≤ε_{A}/ε_{B}, the capacity retention rate of the secondary battery is improved, it can be seen that has a cycling property. It is considered that the active material secondary particles include a polymer having such property, so that the contact between the active material secondary particles and the sulfide solid electrolyte is easy to be achieved, and the binding force between the active material secondary particles and the sulfide solid electrolyte is improved, and further, since the polymer itself also has the deformation performance, the separation between the active material secondary particles and the sulfide solid electrolyte is difficult to occur. In other words, even if the volume of the active material secondary particles (particularly, Si particles) in the negative electrode mixture changes with charge and discharge, it is considered that separation between the active material secondary particles and the sulfide solid electrolyte hardly occurs, and an ionic conduction pass or the like is maintained. As a result, it is considered that the cycle characteristics (capacity retention rate) as a secondary battery was improved. From the above results, it can be said that the cycle characteristics of the secondary battery are improved by configuring the secondary battery using the negative electrode mixture material satisfying the following.

(1) The negative electrode mixture includes active material secondary particles and a sulfide solid electrolyte.

(2) The active material secondary particles include a plurality of silicon particles and a polymer that binds the silicon particles together.

(3) The polymer has a property of 0.37≤ε_{A}/ε_{A}. Here, ε_{A} is a bending strain of the molded body A, and the molded body A consists of the polymer and the sulfide solid electrolyte, contains 20% by volume of the polymer, and has a filling ratio of 90%, ε_{B} is a bending strain of the molded body B, and the molded body B consists of the sulfide solid electrolyte and has a filling ratio of 90%.

### REFERENCE SIGNS LIST

1 Negative electrode mixture
1a Active material secondary particle
1ax Silicon particle
1ay Polymer
1b Sulfide solid electrolyte
100 Secondary battery
10 Positive electrode current collector
20 Positive electrode active material layer
30 Electrolyte layer
40 Negative electrode active material layer
50 Negative electrode current collector

1. A negative electrode mixture, comprising active material secondary particles and a sulfide solid electrolyte, wherein
the active material secondary particles include a plurality of silicon particles and a polymer binding the silicon particles, and
the polymer has the following property:
property: 0.37≤ε_{A}/ε_{B}
ε_{A}: bending strain of molded body A
molded body A: A molded body consisting of the polymer and the sulfide solid electrolyte and including 20% by volume of the polymer and having a filling ratio of 90%
ε_{B}: bending strain of molded body B
molded body B: A molded body consisting of the sulfide solid electrolyte and having a filling ratio of 90%.

2. The negative electrode mixture according to claim 1, wherein
the polymer is a fluorine-based polymer.

3. The negative electrode mixture according to claim 1, wherein
the polymer is a polyvinylidene fluoride-based polymer.

4. A method for producing a negative electrode mixture, the method comprising:
mixing at least a plurality of silicon particles and a polymer to obtain active material secondary particles, and
mixing at least the active material secondary particles and a sulfide solid electrolyte to obtain the negative electrode mixture, wherein
the polymer has the following property:
property: 0.37≤ε_{A}/ε_{B}
ε_{A} : bending strain of molded body A
molded body A: A molded body consisting of the polymer and the sulfide solid electrolyte and including 20% by volume of the polymer and having a filling ratio of 90%
ε_{A} : bending strain of molded body B
molded body B: A molded body consisting of the sulfide solid electrolyte and having a filling ratio of 90%.

5. A secondary battery, comprising a positive electrode active material layer, an electrolyte layer, and a negative electrode active material layer, wherein
the negative electrode active material layer has a negative electrode mixture according to claim 1.
